(19) United States
(12) Patent Application Publication
(10) Pub. No.: US 2005/0159130 A1
(43) Pub. Date: Jul. 21, 2005

(54) Novel DC offset and IP2 correction for down-conversion mixer

(75) Inventors: John-San Yang, Kaohsiung City (TW); Yu-Hua Liu, Beipu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Airoha Technology Corp.

(21) Appl. No.: 11/034,645

(22) Filed: Jan. 13, 2005

(30) Foreign Application Priority Data
Jan. 19, 2004 (TW) 93101327

(51) Int. Cl. H04B 1/16; H04B 1/26; H04B 1/18

(52) U.S. Cl. 455/326; 455/209; 455/293

(57) ABSTRACT

Mixers are provided. A mixer includes an output port, a local oscillation input port, a local mixing driving stage, a radio frequency (RF) input port, a RF driving stage, and first to fourth calibration units. The local oscillation input port comprises first and second local input terminals for receiving a pair of local oscillation signals (LO+ and LO−). The local mixing driving stage comprises first, second, third, and fourth transistors. The first to fourth calibration units are respectively connected in parallel with the first to fourth transistors to constitute first to fourth current path switches, wherein by controlling the switches, the turn-on period of the first and fourth current path switches driven by the local oscillation signal LO+is virtually equal to those of the second and third current path switches driven by the local oscillation signal LO−.

### BACKGROUND

The invention relates to mixers.

Typically, when receiving radio frequency (RF) signals, transceivers down-sample the RF signals to intermediate frequency (IF) signals because it is easier to process IF signals than RF signals. Commonly, transceivers utilize mixers to mix RF signals with local oscillation signals to generate new IF signals. Mixers are categorized into two kinds: single-ended mixers and balanced mixers. Balanced mixers are further categorized into two kinds: single balanced mixers and double balanced mixers.

Gilbert-Cell double balanced mixers are commonly used and comprise a plurality of transistors on a single chip. The circuitry of the transistors is symmetric, such that corresponding transistors have the same dimension and the same doping concentration. However, it is impossible to fabricate two identical transistors in manufacturing process. The slight difference, or asymmetry of corresponding transistors, can cause direct current (DC) deviation at output terminals of Gilbert-Cell double balanced mixers.

FIG. 1 is a diagram of a conventional Gilbert-Cell double balanced mixer. As shown in FIG. 1, the mixer comprises an intermediate frequency (IF) output port, a local oscillation input port, and a radio frequency (RF) input port. The IF output port comprises two IF output terminals for outputting a pair of IF signals, IF+ and IF−, respectively. The local oscillation input port comprises two local input terminals for receiving a pair of local oscillation signals, LO+ and LO−, respectively. The RF input port comprises two RF input terminals for receiving a pair of RF signals, RF+ and RF−, respectively. Bipolar junction transistors (BJT) Q1, Q2, Q3, Q4, Q5, and Q6 are used for mixing the input RF signals RF+ and RF−with the input local oscillation signals LO+ and LO− to generate new IF signals IF+ and IF−at the IF output port respectively. The transistors are supplied with a stable current by a current source I. Gilbert-Cell double balanced mixers are commonly used in communication chips, for up-sampling or down-sampling RF signals. Because output signals of the mixer are down-sampled to IF band directly, signal leakage between the RF input port and the local oscillation input port may cause self-mixing, thereby creating direct current (DC) deviation at the IF output port. If a modulation signal does not contain a DC component, the DC deviation can be cancelled between the mixer stage and the next stage by way of alternating current (AC) coupling technology. However, some communication systems, such as Global System for Mobile Communication (GSM), utilizes a modulation method called Gaussian Minimum Shift Keying (GMSK). In the GMSK method, a modulation signal contains a DC component, thus the AC coupling technology is unsuitable. Instead, the DC deviation is adjusted by way of circuitry technology and DC coupling technology.

### SUMMARY

A mixer is provided. An exemplary embodiment of a mixer comprises an output port, a local oscillation input port, a local mixing driving stage, a radio frequency (RF) input port, a RF driving stage, and first to fourth calibration units. The output port comprises first and second output terminals. The local oscillation input port comprises first and second local input terminals for receiving a pair of local oscillation signals (LO+ and LO−). The local mixing driving stage comprises first, second, third, and fourth transistors, wherein the first transistor is disposed between the first output terminal and a first node, the second transistor is disposed between the second output terminal and the first node, the third transistor is disposed between the first output terminal and a second node, the fourth transistor is disposed between the second output terminal and the second node, both control terminals of the first and fourth transistors are coupled with the first local input terminal, and both control terminals of the second and third transistors are coupled with the second local input terminal. The radio frequency (RF) input port comprises first and second RF input terminals for receiving a pair of RF signals (RF+ and RF−). The RF driving stage supplies first and second direct current (DC) biases to the local mixing driving stage through the first and second nodes respectively. The RF driving stage is coupled with the first and second RF input terminals for transmission of the pair of RF signals to the local mixing driving stage for mixing. The first to fourth calibration units are connected in parallel with the first to fourth transistors to constitute first to fourth current path switches respectively, wherein the turn-on period of the first and fourth current path switches driven by the local oscillation signal LO+is virtually equal to those of the second and third current path switches driven by the local oscillation signal LO−.

Another exemplary embodiment of a mixer comprises a mixing unit, a strength detecting unit, and a current calibration unit. The mixing unit mixes a radio frequency (RF) signal to generate a second frequency. The strength detecting unit detects signal strength of the RF signal and outputs a first current corresponding thereto. The current calibration unit is coupled between an output end of the mixer and an output end of the strength detecting unit. The current calibration unit controls direct current (DC) deviation of an output signal from the mixer according to the signal strength.

### DESCRIPTION OF THE DRAWINGS

Mixers can be more fully understood by reading the subsequent detailed description and examples with references made to the accompanying drawings, wherein:

FIG. 1 is a diagram of a conventional Gilbert-Cell double balanced mixer.

FIG. 2 is a diagram of the equivalent circuits of the conventional mixer in FIG. 1.

FIG. 3 is a schematic diagram of circuits of an embodiment of a mixer.

FIG. 4 is a schematic diagram of circuits of a calibration unit of an embodiment of a mixer.

FIG. 5 is a schematic diagram of circuits of an embodiment of a mixer.

FIG. 6 is a schematic diagram of circuits of a bias calibration unit of an embodiment of a mixer.

FIG. 7 is a block diagram of another embodiment of a mixer.

### DETAILED DESCRIPTION

### First Embodiment

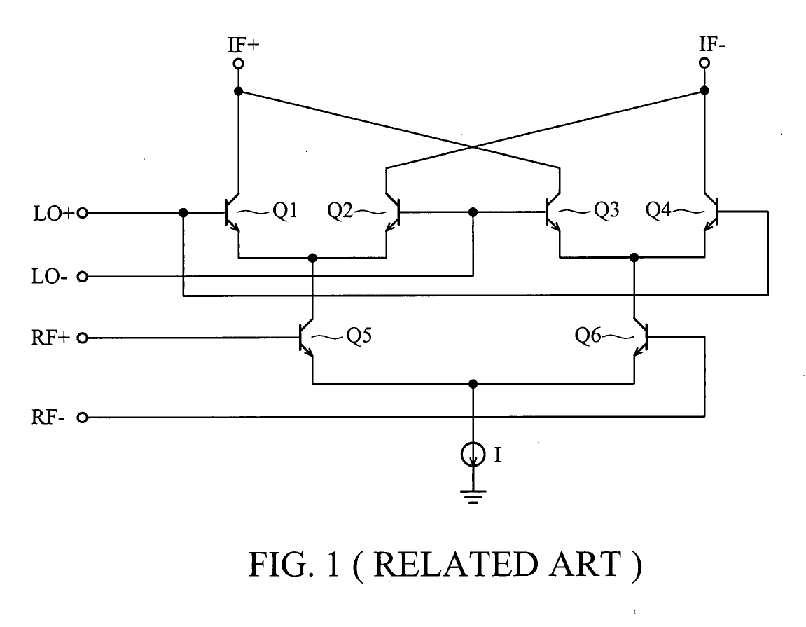

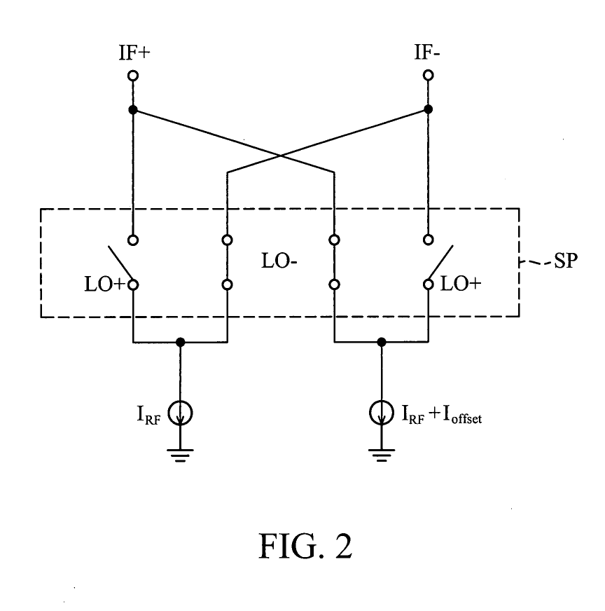

FIG. 2 is a diagram of the equivalent circuits of the mixer in FIG. 1. As shown in FIG. 2, the conventional Gilbert-Cell double balanced mixer is simplified for explanation. Four bipolar junction transistors (BJT) Q1, Q2, Q3, and Q4 of the local oscillation input port constitute a switching pair SP. The RF input port is simulated by two voltage controlled current sources I_{RF} and I_{RF}+I_{offset}.

The turn-on period of the transistors Q1 and Q4 driven by the local oscillation signal LO+ is defined as T1, and the turn-on period of the transistors Q2 and Q3 driven by the local oscillation signal LO− is defined as T2. Thus, the current of the IF signal IF+ is

$${I}_{RF} + \frac{T2}{T1 + T2} \cdot {I}_{offset} ,$$

and the current of the IF signal IF− is

$${I}_{RF} + \frac{T1}{T1 + T2} \cdot {I}_{offset} .$$

When the duty cycle of the local oscillation input port is 50%, i.e. T1 equals T2, the IF output port of the mixer contains no DC deviation, thus eliminating self-mixing.

In an embodiment of the invention, when the duty cycle is not 50%, i.e. T1 is shorter than T2, or vice versa, a plurality of transistors is coupled to the transistors corresponding to the shorter turn-on period to extend the shorter turn-on period, thereby equalizing the two turn-on periods T1 and T2. Therefore, the duty cycle is adjusted to 50%, and self-mixing is eliminated.

In another embodiment of the invention, a current-steering digital-to-analog converter (DAC) is used to adjust a DC bias of the transistor Q5 or Q6, thereby equalizing. DC biases of the transistors Q5 and Q6.

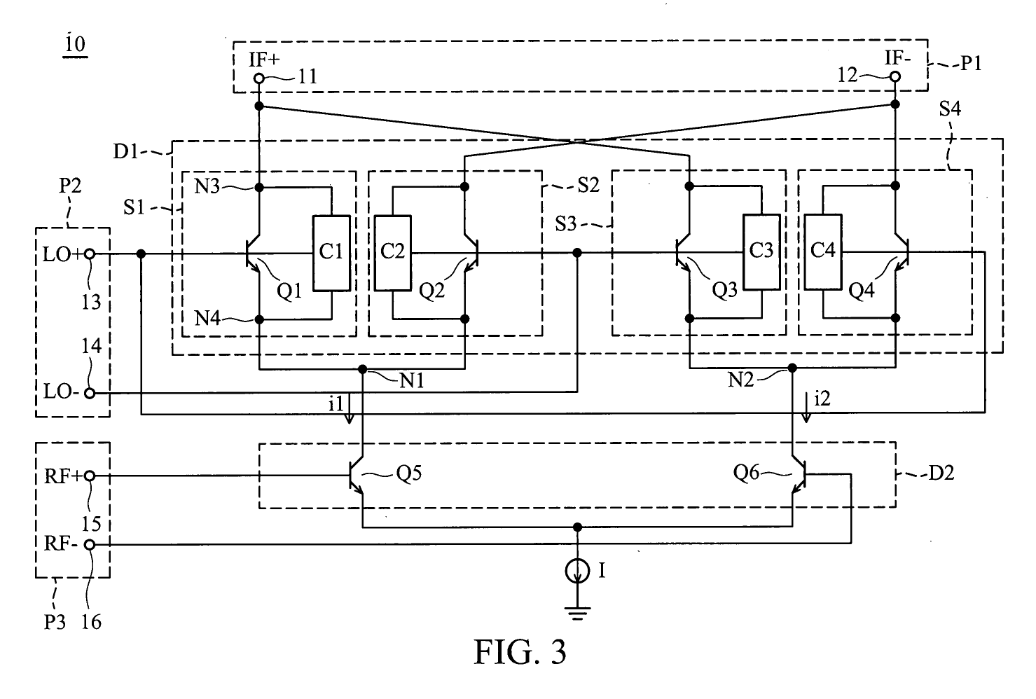

FIG. 3 is a schematic diagram of circuits of a mixer 10 according to the first embodiment of the invention. As shown in FIG. 3, the mixer 10 comprises an intermediate frequency (IF) output port P1, a local oscillation input port P2, a local mixing driving stage D1, a radio frequency (RF) input port P3, a RF driving stage D2, and four calibration units C1, C2, C3, and C4. The IF output port P1 comprises two IF output terminals 11 and 12 for outputting a pair of IF signals, IF+ and IF−, respectively. The local oscillation input port P2 comprises two local input terminals 13 and 14 for receiving a pair of local oscillation signals, LO+ and LO−, respectively. The local mixing driving stage D1 comprises four bipolar junction transistors (BJT) Q1, Q2, Q3, and Q4. The transistor Q1 is disposed between the output terminal 11 and a node N1, the transistor Q2 is disposed between the output terminal 12 and the node N1, the transistor Q3 is disposed between the output terminal 11 and a node N2, and the transistor Q4 is disposed between the output terminal 12 and the node N2. Both control terminals of the transistors Q1 and Q4 are coupled with the local input terminal 13, and both control terminals of the transistors Q2 and Q3 are coupled with the local input terminal 14. The RF input port P3 comprises two RF input terminals 15 and 16 for receiving a pair of RF signals, RF+ and RF−, respectively. The RF driving stage D2 comprises a current source I, and two BJT transistors Q5 and Q6. The current source I supplies the transistors Q5 and Q6 with a stable current. The transistor Q5 is disposed between the current source I and the node N1, and the transistor Q6 is disposed between the current source I and the node N2. The RF driving stage D2 supplies two direct current (DC) biases i1 and i2 to the local mixing driving stage D1 through the nodes N1 and N2 respectively. Also, the RF driving stage D2 is coupled with the two RF input terminals 15 and 16 for transmission of the pair of RF signals, RF+ and RF−, to the local mixing driving stage D1 for mixing. The four calibration units C1, C2, C3, and C4 are connected in parallel with the four transistors Q1, Q2, Q3, and Q4 to constitute four current path switches S1, S2, S3, and S4 respectively.

In the mixer 10, the local mixing driving stage D1 mixes the input RF signals RF+ and RF−with the input local oscillation signals LO+ and LO− to generate new IF signals IF+ and IF−at the IF output port P1 respectively.

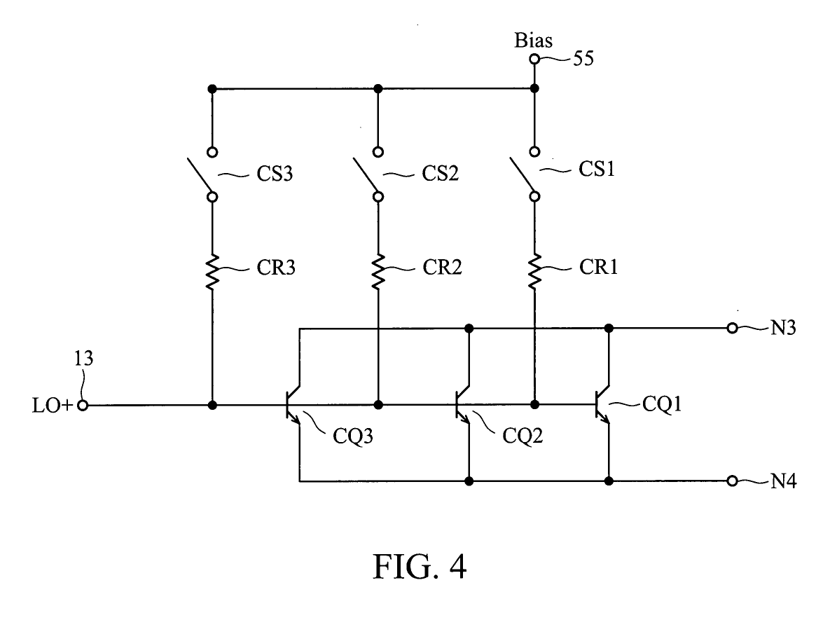

FIG. 4 is a schematic diagram of circuits of a calibration unit C1 of the mixer 10 according to the first embodiment of the invention. In the mixer 10, circuit structures of the calibration unit C1 and the calibration unit C4 are the same. Thus, only the circuit structure of the calibration unit C1 is described as an example herein for simplicity. As shown in FIG. 4, the calibration unit C1 comprises three calibration BJT transistors CQ1, CQ2, and CQ3 connected in parallel. The three calibration BJT transistors CQ1, CQ2, and CQ3 are coupled to a collector and an emitter of the transistor Q1 through nodes N3 and N4 respectively. Control terminals of the three calibration BJT transistors CQ1, CQ2, and CQ3 are coupled to a node 55 to receive a bias Bias through a plurality of switching units CS1, CS2, and CS3 and a plurality of resistors CR1, CR2, and CR3 respectively. The calibration unit C1 adjusts the turn-on period of the current path switch S1 by controlling the switching units CS1, CS2, and CS3. Similarly, the calibration unit C4 adjusts the turn-on period of the current path switch S4. Also, circuit structures of the calibration unit C2 and the calibration unit C3 are the same and similar to those of the calibration unit C1 except that different biases are used. Thus, the calibration unit C2 adjusts the turn-on period of the current path switch S2, and the calibration unit C3 adjusts the turn-on period of the current path switch S3.

Therefore, after adjustment, the turn-on period of the current path switches S1 and S4 driven by the local oscillation signal LO+is virtually equal to those of the current path switches S2 and S3 driven by the local oscillation signal LO−. Thus, the duty cycle is adjusted to 50%, the local mixing driving stage D1 is symmetric in circuitry, and DC deviation caused by self-mixing is eliminated.

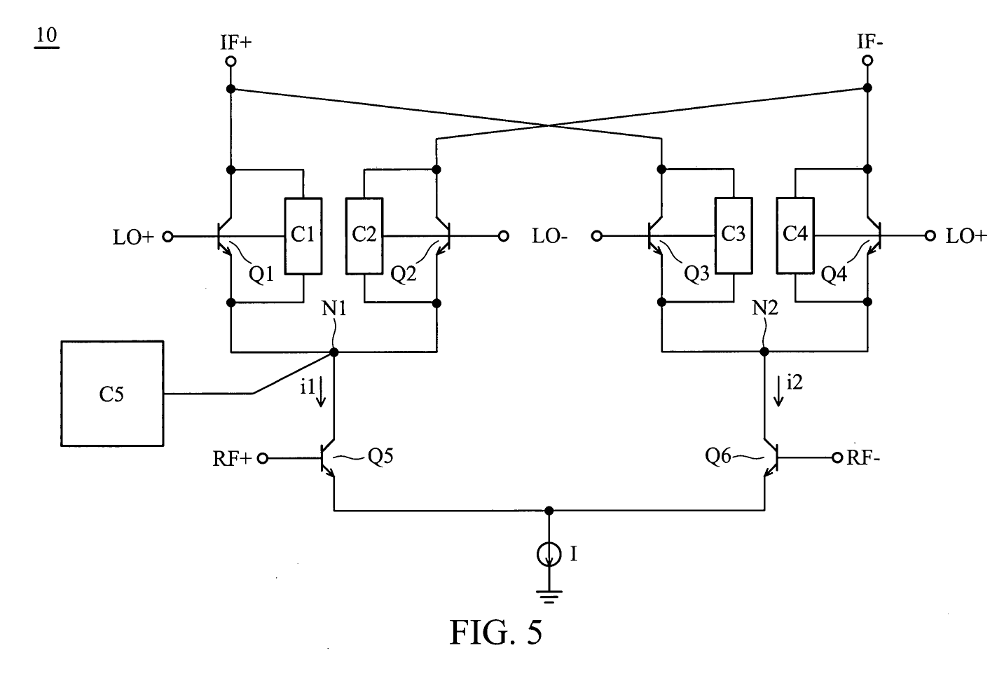

FIG. 5 is a schematic diagram of circuits of a mixer 10 according to the first embodiment of the invention. For better performance, the mixer 10 optionally comprises at least a bias calibration unit coupled with the node N1 or N2 for adjusting a DC bias of the transistor Q5 or Q6, thereby equalizing the two DC biases i1 and i2 supplied to the local mixing driving stage D1. In other words, the DC difference between the two DC biases i1 and i2 is decreased. As shown in FIG. 5, the mixer 10 further comprises a bias calibration unit C5 coupled with the node N1 for adjusting a DC bias of the transistor Q5 to adjust the DC bias i1, thereby equalizing the two DC biases i1 and i2 supplied to the local mixing driving stage D1. In other words, the DC difference between the two DC biases i1 and i2 is decreased. The bias calibration unit C5 can be a bias circuit constituted by current-steering digital-to-analog converters (DAC).

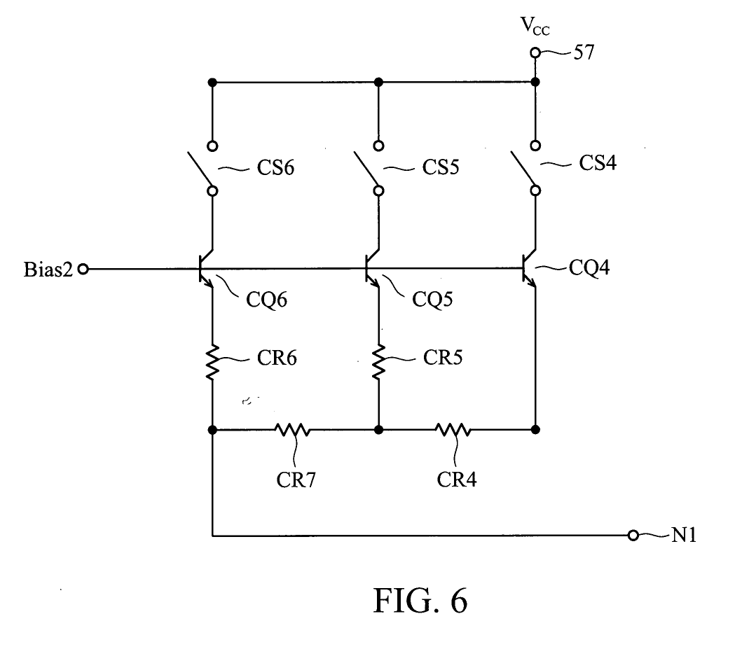

FIG. 6 is a schematic diagram of circuits of a bias calibration unit C5 of the mixer 10 according to the first embodiment of the invention. As shown in FIG. 6, the bias calibration unit C5 comprises three calibration BJT transistors CQ4, CQ5, and CQ6 connected in parallel. Collectors of the three calibration BJT transistors CQ4, CQ5, and CQ6 are coupled to a node 57 to receive a voltage Vcc through a plurality of switching units CS4, CS5, and CS6 respectively. A bias Bias2 is supplied to bases of the three calibration BJT transistors CQ4, CQ5, and CQ6. Four resistors CR4, CR5, CR6, and CR7 are coupled between the node N1 and emitters of the three calibration BJT transistors CQ4, CQ5, and CQ6. The transistors CQ4, CQ5, and CQ6 are fabricated under different parameters, so current from the emitter of each transistor is of different value. For example, the current values can form a geometric sequence with a common ratio 2. The bias calibration unit C5 outputs an appropriate current to the node N1 to adjust the DC bias i1, thereby equalizing the two DC biases i1 and i2 supplied to the local mixing driving stage D1 by controlling the switching units CS4, CS5, and CS6.

### Second Embodiment

In a mixer, DC deviation of a signal output therefrom is directly proportional to signal strength of a signal input thereto. Thus DC deviation can be cancelled by a calibration current generated by a peak detector detecting the signal strength of the input signal to the mixer.

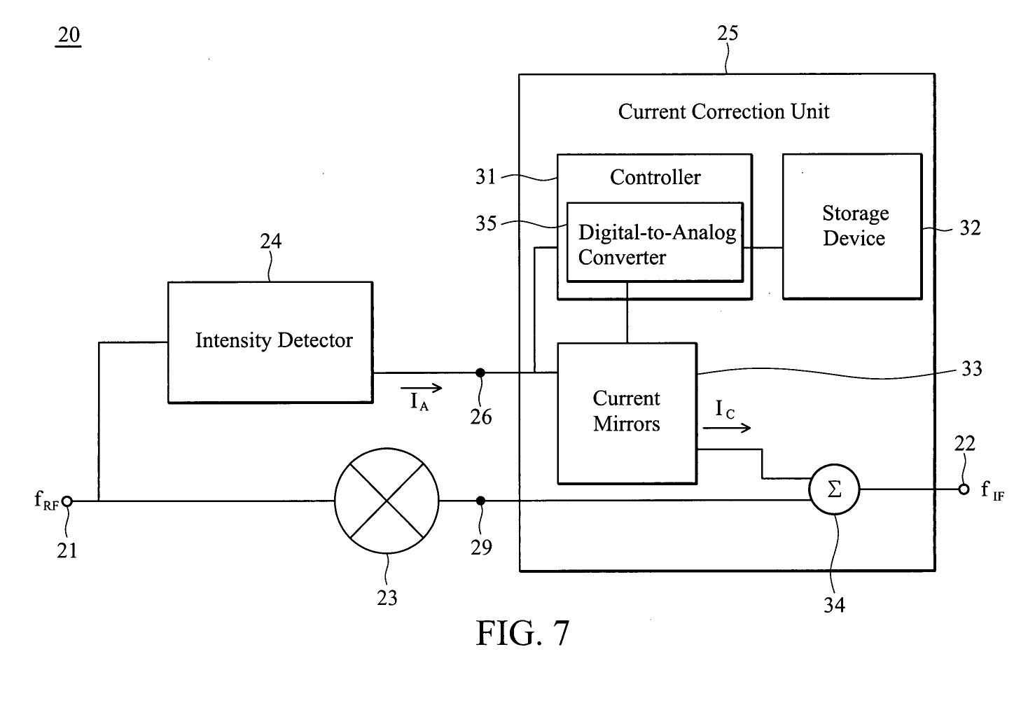

FIG. 7 is a block diagram of a mixer 20 according to the second embodiment of the invention. The mixer 20 comprises a mixing unit 23, a strength detecting unit 24, and a current calibration unit 25. The mixing unit 23 mixes a radio frequency (RF) signal f_{RF} to generate a second frequency f_{IF}. The strength detecting unit 24 detects signal strength of the RF signal f_{RF} and generates a reference current I_{A} corresponding to the signal strength, wherein corresponding relationship of the RF signal f_{RF} and the reference current I_{A} is adjustable.

The current calibration unit 25 is coupled to an output end 26 of the strength detecting unit 24, an output end 29 of the mixing unit 23, and an output end 22 of the mixer 20. The current calibration unit 25 comprises a storage device 32, a plurality of current mirrors 33, a controller 31, and an adder 34. The storage device 32 stores the experimental data obtained from previous experiments. In other words, the relationship between previously measured signal strength and a direct current (DC) bias of an output signal, i.e. the second frequency f_{IF}, is recorded in the storage device 32 for further lookup. The current mirrors 33 comprises a plurality of transistors and receives the reference current I_{A} as its reference current to generate a calibration current I_{C}. The value of the calibration current I_{C} is a multiple of the value of the reference current I_{A}.

The controller 31 comprises a digital-to-analog converter (DAC) 35. When the DAC 35 receives the reference current I_{A} from the strength detecting unit 24, the DAC 35 calculates the signal strength. The DAC 35 then reads the experimental data corresponding to the signal strength out of the storage device 32 and accordingly drives output of a plurality of digital control bits of the DAC 35 to turn the transistors of the current mirrors 33 on or off, thereby determining a conversion ratio of the current mirrors 33, i.e. the ratio of the value of the calibration current I_{C} to the value of the reference current I_{A}.

Finally, the adder 34 receives the output signal from the output end 29 of the mixing unit 23 and the calibration current I_{C}. The adder 34 then compensates DC deviation of the output signal of the mixing unit 23 by the calibration current I_{C}. Thus, DC deviation of the output signal f_{IF} of the mixer 20 is maintained within a small range.

While the invention has been described by way of example and in terms of several embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mixer, comprising:
an output port comprising first and second output terminals;
a local oscillation input port comprising first and second local input terminals for receiving a pair of local oscillation signals (LO+ and LO−);
a local mixing driving stage comprising first, second, third, and fourth transistors, wherein the first transistor is disposed between the first output terminal and a first node, the second transistor is disposed between the second output terminal and the first node, the third transistor is disposed between the first output terminal and a second node, the fourth transistor is disposed between the second output terminal and the second node, both control terminals of the first and fourth transistors are coupled with the first local input terminal, and both control terminals of the second and third transistors are coupled with the second local input terminal;
a radio frequency (RF) input port comprising first and second RF input terminals for receiving a pair of RF signals (RF+ and RF−);
a RF driving stage supplying first and second direct current (DC) biases to the local mixing driving stage through the first and second nodes respectively, and coupled with the first and second RF input terminals for transmission of the pair of RF signals to the local mixing driving stage for mixing; and
first to fourth calibration units connected in parallel with the first to fourth transistors to constitute first to fourth current path switches respectively, wherein the turn-on period of the first and fourth current path switches driven by the local oscillation signal LO+is virtually equal to those of the second and third current path switches driven by the local oscillation signal LO−.

2. The mixer as claimed in claim 1, wherein the first and fourth calibration units both comprise a plurality of calibration transistors connected in parallel, of which all control terminals are coupled to a first bias through a plurality of switching units respectively, the second and third calibration units both comprise a plurality of calibration transistors connected in parallel, of which all control terminals are coupled to a first bias through a plurality of switching units respectively, the turn-on period of the first and fourth current path switches is adjusted by controlling the corresponding switching units, and the turn-on period of the second and third current path switches is adjusted by controlling the corresponding switching units.

3. The mixer as claimed in claim 1 further comprising at least a first bias calibration unit coupled with the first or the second node and adjusting the first or the second DC bias to virtually equalize DC current values thereof.

4. The mixer as claimed in claim 1, wherein the RF driving stage comprises a current source, a fifth transistor coupled between the current source and the first node, and a sixth transistor coupled between the current source and the second node, the mixer further comprising at least a first bias calibration unit adjusting a DC bias of the fifth or the sixth transistor to equalize DC current values of the first and second DC biases.

5. The mixer as claimed in claim 4, wherein the first bias calibration unit is a bias circuit constituted by current-steering digital-to-analog converters (DAC).

6. A mixer, comprising:
a mixing unit for mixing a radio frequency (RF) signal to generate a second frequency;
a strength detecting unit for detecting signal strength of the RF signal and outputting a first current corresponding thereto; and
a current calibration unit coupled between an output end of the mixer and an output end of the strength detecting unit and controlling direct current (DC) deviation of an output signal from the mixer according to the signal strength.

7. The mixer as claimed in claim 6, wherein the current calibration unit is a digital-to-analog converter (DAC) utilizing the first current as its reference current.

8. The mixer as claimed in claim 7, wherein a conversion ratio corresponding to the reference current is determined by a plurality of digital control bits of the DAC.

9. The mixer as claimed in claim 6, wherein the current calibration unit comprises:
a plurality of current mirrors comprising a plurality of transistors, receiving the first current as a reference current, and generating a calibration current coupled to the output end of the mixer, wherein the value of the calibration current is a multiple of the value of the reference current; and
a controller turning the transistors on or off according to the signal strength to determine a conversion ratio of the current mirrors and the value of the calibration current, based on a plurality of experimental data.

10. The mixer as claimed in claim 9, wherein the current calibration unit further comprises an adder receiving the output signal from the mixer and the calibration current to control DC deviation of the output signal from the mixer.

11. The mixer as claimed in claim 9 further comprising a storage device storing the experimental data.

12. The mixer as claimed in claim 11, wherein the controller comprises a DAC reading the experimental data corresponding to the signal strength out of the storage device and accordingly driving outputs of a plurality of digital control bits of the DAC to turn the transistors on or off.
